(19) United States
(12) Patent Application Publication
(10) Pub. No.: US 2013/0249520 A1
(43) Pub. Date: Sep. 26, 2013

(54) BOOST REGULATOR WITH TIMING CONTROLLED INDUCTOR BYPASS

(71) Applicants: Juha Joonas Oikarinen, Santa Clara, CA (US); Juha-Matti Kujala, Kokkola (FI); Jonathan Klein, Palo Alto, CA (US)

(72) Inventors: Juha Joonas Oikarinen, Santa Clara, CA (US); Juha-Matti Kujala, Kokkola (FI); Jonathan Klein, Palo Alto, CA (US)

(73) Assignee: Fairchild Semiconductor Corporation, San Jose, CA (US)

(21) Appl. No.: 13/826,341

(22) Filed: Mar. 14, 2013

Related U.S. Application Data
(60) Provisional application No. 61/614,711, filed on Mar. 23, 2012.

(51) Int. Cl. H02M 3/157

(52) U.S. Cl. CPC H02M 3/157
USPC 323/285

(57) ABSTRACT

Apparatus and methods of implementing a voltage converter bypass switch, among other things, are discussed herein. In certain examples, a boost converter can include a bypass switch configured to bypass an inductor and a transistor of the boost converter to more directly couple a supply voltage to an output of the boost converter during a bypass mode, and to isolate a supply voltage input from the output during a boost mode of the boost converter.

### CLAIM OF PRIORITY

This application claims the benefit of priority under 35 U.S.C. 119(e) to Oikarinen et al., U.S. Provisional Patent Application Ser. No. 61/614,711, entitled, “BOOST REGULATOR WITH TIMING CONTROLLED INDUCTOR BYPASS,” filed Mar. 23, 2012, hereby incorporated by reference herein in its entirety.

### OVERVIEW

This document discusses, among other things, voltage converters, and more particularly, voltage converters including a bypass switch. In certain examples, a boost converter can include a first input configured to couple to a first terminal of an inductor, a second input configured to couple to a voltage source and a second terminal of the inductor, an output configured to provide an output voltage to a load, a first transistor configured to initiate a charging current in the inductor during a first state of a boost mode and to isolate the first input from ground in a second state of the boost mode, a second transistor configured to couple the first input to the output during the second state of the boost mode and to isolate the first input from the output during the first state of the boost mode and a bypass switch configured to couple the second input to the output and to bypass the inductor and the second transistor during a bypass mode, and to isolate the second input from the output during the boost mode.

In certain examples, the bypass switch can include a metal oxide semiconductor field effect transistor (MOSFET) having a drain node and a source node coupled in series between the second input and the output, a first switch coupled between a bulk node of the MOSFET and the drain, and a second switch coupled between the bulk node and the source.

This overview is intended to provide a general overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example computed on-time boost converter system.

FIG. 2 illustrates generally a flow chart of an example method of operating a boost converter.

FIGS. 3A and 3B illustrate graphically input voltage, output voltage, inductor current, and bypass current of an example boost converter

FIGS. 4A-4D provide waveforms associated with a boost system that does not bypass the inductor (FIGS. 4A and 4B) and an example boost converter that does bypass the inductor (FIGS. 4C and 4D).

### DETAILED DESCRIPTION

Voltage converters such as buck, or boost converters, can receive a direct current (DC) input voltage and can provide at an output a DC output voltage that differs from the input voltage. In certain examples, the output voltage can be at near the input voltage during certain intervals of operation of the voltage converter. In certain examples, a boost converter, or regulator, can provide a minimum voltage rail for applications where it is likely the input voltage can fall below the desired voltage of the minimum voltage rail. Such applications can include, but are not limited to, battery operated devices such as mobile electronic devices.

In certain examples, the higher output voltage of a boost converter can be provided by storing energy in an inductor and releasing the stored energy to charge an output capacitor, or a capacitive load, to a desired output voltage level. Energy can be stored in an inductor by initiating or increasing current through the inductor. The stored energy of the inductor current can then be released to charge the output capacitor to a desired voltage level.

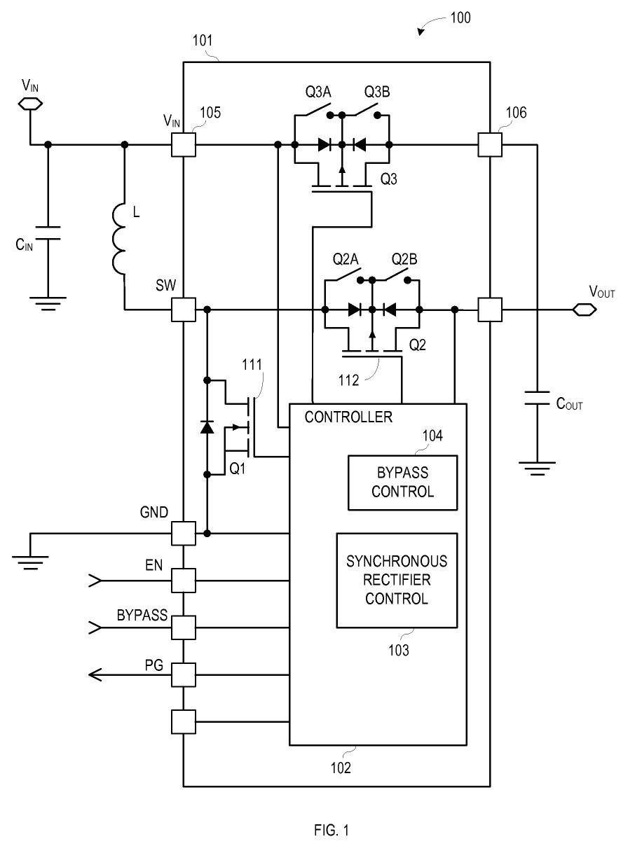

FIG. 1 illustrates generally an example boost converter system 100, such as a computed on-time boost converter system, including a input capacitor (C_{IN}), an inductor (L), a boost converter 101 and an output capacitor (C_{OUT}). In certain examples, the boost converter 101, input capacitor (C_{IN}) and the inductor can be coupled to an input supply providing an DC input voltage (V_{IN}). In certain examples, the boost converter can provide an DC output voltage (V_{OUT}) to a load and the output capacitor (C_{OUT}). In certain examples, the boost converter can include a controller 102, a first transistor (Q1) 111, a second transistor (Q2) 112, and third or bypass transistor (Q3) 113. In certain examples, the first transistor 111 of the boost converter 101 can be controlled into a low impedance mode to initiate or increase current through the inductor (L) by coupling a second terminal (SW) of the inductor (L) to ground (GND) during an on-time interval of a boost mode of the boost converter 101. In certain example, during an off-time of a boost mode of the boost converter 101, the second transistor 112 can couple the second terminal (SW) of the inductor (L) to an output of the boost converter 101, for example, to charge the load capacitor (C_{OUT}) to a desired output voltage level. In certain examples, a synchronous rectifier control module 103 associated with the controller can coordinate on and off times of the first and second transistors 111, 112 during the boost mode. In certain examples, the output voltage (V_{OUT}) of the boost converter 101 can be at least partially controlled by one or more pulse trains generated by the controller 102 and received by the first and second transistors 111, 112. In certain examples, a duty cycle can be associated with a pulse train. Duty cycle can refer to an ON:OFF ratio that indicates the ratio of the time duration of each pulse (an ON time) that is delivered versus the time duration between successive pulses (an OFF time). In certain examples, the boost mode of the boost converter can be used to ensure the output voltage (V_{OUT}) supplied by the boost converter maintains a minimum voltage level during times when the input voltage (V_{OUT}) is below the minimum voltage level. In some examples, when the input voltage (V_{IN}) is at or near the output voltage (V_{OUT}), the switching frequency of the boost controller can slow.

In certain examples, the boost converter 101 can include a bypass transistor (Q3) 113 and a bypass control module 104 associated with the controller 102. In some examples, the bypass transistor 113 can allow the boost converter 101 to directly couple an input voltage terminal 105 to an output voltage terminal 106. For example, when the input voltage (V_{IN}) is at or above a desired output voltage level, the efficiency of the boost converter 101 can be improved by directly coupling the input voltage terminal 105 to the output voltage terminal 106 to provide the output voltage (V_{OUT}). At least a portion of the efficiency improvement of the boost converter 101 can be realized the bypass switch can eliminate switching losses associated with the first and second transistors 111, 112. In addition, the third transistor, or bypass transistor, is configured to bypass the inductor (L). In certain existing boost systems, a bypass mode may include operating the second transistor with 100% duty cycle. In certain examples, bypassing the inductor with the bypass transistor 113 can eliminate ringing that can associated with the inductor (L), and the input and output capacitors (C_{IN}, C_{OUT}) when only the second transistor 112 is used as a bypass switch. In certain examples, the bypass mode can include placing both the bypass transistor 113 and the second transistor 112 in low impedance states to couple the input voltage (V_{IN}) to the output voltage (V_{OUT}). In such an examples, the current capacity of the bypass mode can be about the twice the current capacity of the boost mode.

In certain examples, transitions between the bypass mode and the boost mode can be executed after certain conditions are met. In some examples, the controller 102 can transition from the boost mode to the bypass mode when the input voltage (V_{IN}) is greater than the output voltage (V_{OUT}), the output voltage (V_{OUT}) is at or above a target output voltage, and the synchronous rectifier control module 103 has not changed the state of the first transistor 111 for a predetermined transition interval. In certain examples, when the input voltage (V_{IN}) is near the output voltage (V_{OUT}), the predetermined transition interval can prevent the boost converter oscillating bypass mode and boost mode.

In certain examples, the bypass control module 104 can ramp the turn on of the bypass transistor 113 over a predetermined interval to soften the transition and to reduce current and voltage spikes of the boost converter system 100. In certain examples, the controller 102 can include a comparator to quickly transition from the bypass mode to the boost mode if the output voltage (V_{OUT}) becomes less than the target output voltage.

In certain examples, the controller can transition to and remain in the bypass mode in response to a forced bypass command or input or signal (BYPASS). In some example, the controller can immediately transition from the boost mode to the bypass mode regardless of the difference or relationship between the input voltage (V_{IN}) and the output voltage (V_{OUT}). In some examples, if a forced bypass command is received, and the output voltage (V_{OUT}) is greater than the input voltage (V_{IN}), the controller can disable the boost mode and wait for the load to discharge the output voltage (V_{OUT}) down to the level of the input voltage (V_{IN}), and the place at least the third transistor, and possibly the second transistor, in a low impedance state to enable the bypass mode and couple the input voltage source to the load. In certain applications, the forced bypass mode can allow the boost converter system 100 to operate in a low quiescent current state with low impedance. The forced bypass mode can be beneficial in situations when the larger system goes in to a sleep mode and the battery voltage is high enough for operation. For example, if only 2.5 volts (V) is needed at the output of the boost converter and input voltage (V_{IN}) is at 2.5 V, forced bypass mode can provide a 2.5 V output voltage (V_{OUT}) even if the target regulation voltage is 3.5 V.

In certain examples, upon exiting a forced bypass mode, the controller 102 can ramp a threshold voltage from the input voltage (V_{IN}) to a value representative of the target regulation voltage to avoid large in-rush current at the transition from the forced bypass mode to the boost mode.

In certain examples, the bypass transistor 113, can include body substrate switches (Q3A, Q3B) to couple the bulk of the bypass transistor 113 to the higher voltage potential of the input voltage (V_{IN}) or the output voltage (V_{OUT}). In some examples, when the output voltage (V_{OUT}) is higher than the input voltage (V_{IN}) the first body substrate switch (Q3A) can be closed and the second body substrate switch (Q3B) can be open. In some examples, when the input voltage (V_{IN}) is greater than the output voltage (V_{OUT}) the second body substrate switch (Q3B) can be closed and the first body substrate switch (Q3A) can be open.

In certain examples, the second transistor 112 can include first and second body substrate switches (Q2A, Q2B) to assist the boost mode and to provide true load disconnect. In some examples, when the output voltage (V_{OUT}) is less than the input voltage (V_{IN}), the first body substrate switch (Q2A) of the second transistor 112 can be closed and the second body substrate switch (Q2B) can be open to provide true load disconnect. In some examples, when the output voltage (V_{OUT}) is greater than the input voltage (V_{IN}), the second body substrate switch (Q2B) can be closed and the first body substrate switch (Q2A) can be open.

In certain examples, the boost converter 101 can include a power good (PG) output. The power good (PG) output can assume a first state when the output voltage (V_{OUT}) is within regulation, the self-start of the boost converter 101 is completed, and no overload conditions exist. In certain examples, the power good (PG) output can include an open drain and can be pulled to a low logic level when there is a fault. In certain examples, the boost converter 101 can include a short circuit comparator. The short circuit comparator can compare a voltage across the bypass transistor 113 during the bypass mode and can provide a short circuit indication if the voltage across the bypass transistor 113 satisfies a short circuit threshold. In certain examples, the boost converter 101 can include a comparator for comparing a representation of an output voltage of the boost converter 101 to a threshold to provide a feedback for the boost mode of the boost converter 101.

In certain examples, the boost converter 101 can include a current feedback to stabilize the boost regulator in during continuous conduction modes. Continuous conduction modes cab characterized as intervals when the inductor current in boost operation does not fall to zero during the switching cycle. In certain examples, current feedback can help maintain single pulse switching in discontinuous conduction modes (e.g., at light loads when the inductor current does go back to zero between the on-time pulses.) In certain examples, the boost converter 101 can include an additional supervisory error amplifier to compensate the voltage droop that can be introduced by the current feedback information. Since bypass entry/exit logic can be based on the timing and difference between the input voltage (V_{IN}) and the output voltage (V_{OUT}), the bypass entry/exit point can be modulated by the load current.

The error amplifier must compensate the current feedback signal induced droop, this results in some undershoot when exiting the bypass mode and also adds some variance to the bypass exit threshold with high dV/dt Vin transients when error amp is lagging behind the high bandwidth current feedback signal.

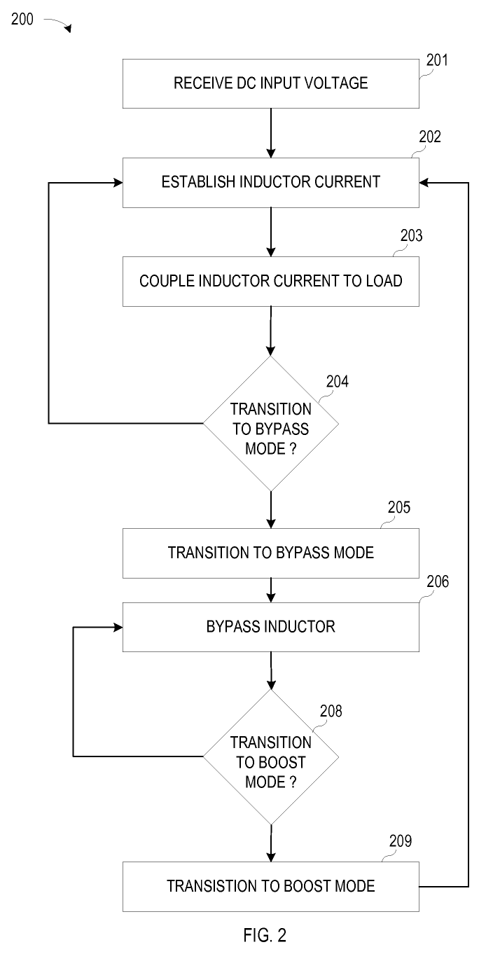

FIG. 2 illustrates generally a flow chart of an example method 200 of operating a boost converter. At 201, the boost controller can receive a DC input voltage. At 202, a first transistor can be used to establish or increase current through, or of, an inductor during an on-time of the boost converter. At 203, the inductor current can be coupled to a load to provide a boosted DC output voltage using a second transistor. At 204, a controller of the boost converter can monitor a number of conditions to determine whether the boost converter should transition to a bypass mode of operation. If the controller determines the boost converter should remain in a boost mode of operation, the alternate switching of the first and second transistors can continue so as to provide a desired DC output voltage to the load.

In certain examples, conditions that can be considered for transitioning to the bypass mode include whether the input voltage is approaching, at, or near the output voltage, whether the output voltage is at or above a desired output voltage, whether the first transistor has not switched for a threshold duration, whether the boost converter has received a forced response command, for example, via an input, or combinations thereof. In certain examples, the threshold duration can range from about 2 microseconds (μsec) to about 1 μsec or more. In an example, the threshold duration can be about 5 μsec.

At 205, the boost converter can transition from the boost mode to the bypass mode. In certain examples, transitioning to the bypass mode can include transitioning the first transistor to a high impedance state, transitioning the second transistor to a low impedance state, transitioning the third, or bypass, transistor to a low impedance state. In some examples, transitioning from the boost state to the bypass state can include waiting for the output voltage to discharge to the level of the input voltage, such as when the boost controller is forced into bypass mode in some circumstances. In some examples, transitioning of the boost converter from the boost mode of operation to the bypass mode of operation can include softly coupling the input voltage to the output voltage using the bypass transistor to avoid high in-rush currents when the input voltage is substantially higher than the output voltage.

At 206, at least the bypass transistor can be fully on, or in a low impedance state, to bypass or reduce the effect of the inductor of the boost converter in coupling the input voltage to the output voltage. In certain examples, at 206, the second transistor can be in a low impedance state to complement the bypass transistor in coupling the input voltage to the load. At 207, the controller of the boost converter can monitor a number of conditions to determine whether the boost converter should transition to the boost mode of operation. In certain examples, conditions for determining whether to transition from the bypass mode to the boost mode can include, but are not limited to, whether the output voltage is below the desired output voltage, whether a forced bypass command no longer exists, or combinations thereof. At 208, the boost converter can transition from the bypass mode to the boost mode. In certain examples, transitioning to the boost mode can include sampling the input voltage and ramping a reference voltage from a value representative of the input voltage to a value representative of the desired output voltage to softly start the boost controller.

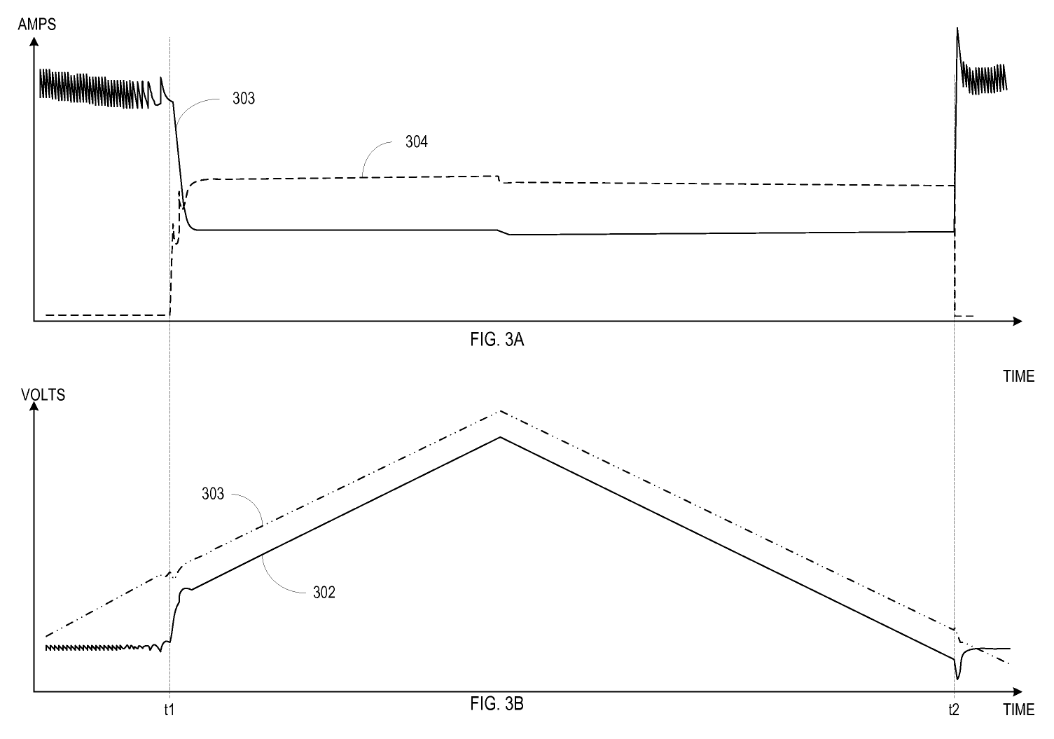

FIGS. 3A and 3B illustrate graphically input voltage 301, output voltage 302, inductor current 303, and bypass current 304 of an example boost converter. At a first transition (t1), FIGS. 3A and 3B shows the boost converter transitioning from boost mode to bypass mode. In certain examples, at the first transition (t1), the bypass current 304 can oscillate as it rises due to output voltage rate limiting. Also, leading up to the first transition (t1), note that the inductor current 303 can oscillate. The inductor current 303 oscillations can be attributed to the switching of the transistors of the boost controller during boost mode such as the first and second transistors 111, 112 of FIG. 1. Also note that the frequency of the inductor current 303 oscillations can slow as the input voltage 301 becomes greater than the output voltage 302. At the first transition (t1), the oscillation can cease as the converter transitions to the bypass mode. In certain examples, such as the one illustrated in FIG. 3A, the inductor current 303 does not go to zero because one of the boost transistors, such as the second transistor 112 of the system illustrated in FIG. 1, can be in a low impedance state during the bypass mode. When operating in the bypass mode, the output voltage 302 can track the trajectory of the input voltage 301 with a slight voltage drop due to the bypass circuitry. As the output voltage falls below a desired level, the boost converter can make a second transition (t2) from the bypass mode to the boost mode. During the second transition (t2) to the boost mode, the bypass transistor can be turned off and the bypass current 304 can go to zero.

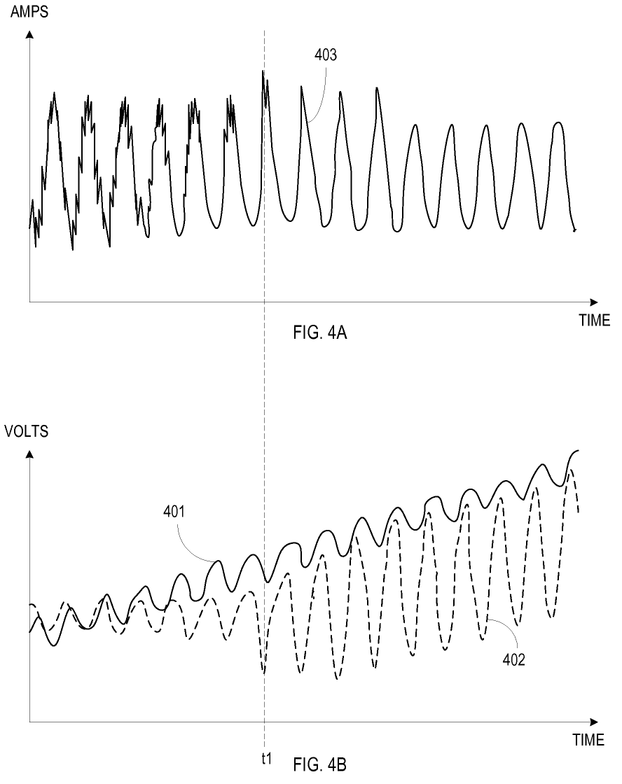

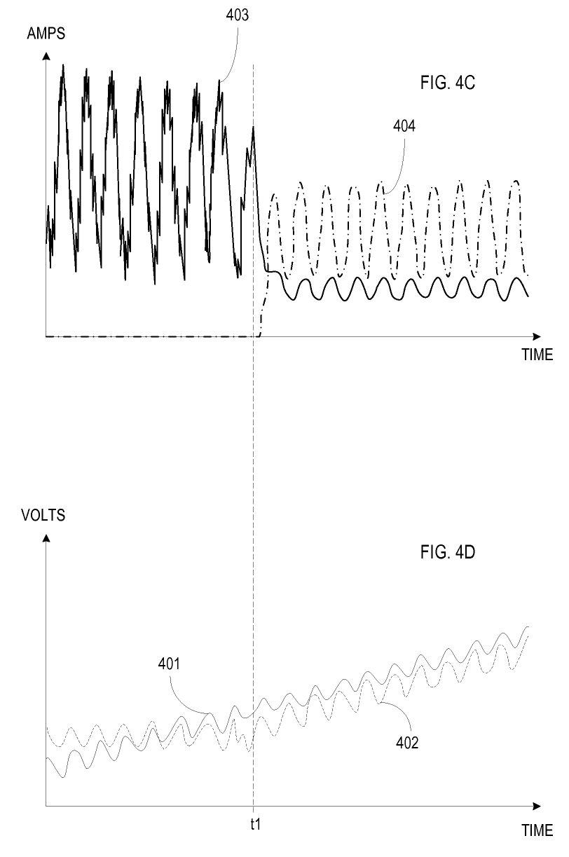

FIGS. 4A-4D illustrate a comparison of a boost system that does not bypass the inductor (FIGS. 4A and 4B) and an example boost converter that does bypass the inductor (FIGS. 4C and 4D). FIGS. 4A and 4B illustrate input voltage 401, output voltage 402 and inductor current 403 of a transition (t1) of a boost system from boost mode to bypass mode that does not bypass the inductor of the system. The inductor, in combination with capacitance of the system, such as an input capacitor coupled to the voltage supply and an output capacitor coupled to the boost converter output, can introduce, sustain or increase output voltage 402 ringing, especially at or near resonance frequencies associated with the inductance and capacitance of the system. Cascaded DC-to DC converters used with a boost system associated with the plots of FIGS. 4A and 4B can be subject to interference and instability due to the large ringing of the output voltage 402.

FIGS. 4C and 4D illustrate input voltage 401, output voltage 402, bypass current 404 and inductor current 403 associated with a transition from boost mode to bypass mode of an example boost system that bypasses the inductor of the boost system during the bypass mode of operation. FIG. 4D shows some oscillation of the output voltage 402, but because the inductor of the boost system is bypassed, the oscillation of the output voltage 402 is merely indicative of the output voltage 402 tracking the oscillation of the input voltage 401. In certain examples, providing a bypass current path around the inductor of the boost system can attenuate ringing of the output voltage 402 and can increase the current capacity of the boost converter as both the bypass transistor and the boost transistor coupling the inductor to the output can reliably conduct current at their rated capacities.

### Additional Notes

In example 1, a boost converter can include a first input configured to couple to a first terminal of an inductor, a second input configured to couple to a voltage source and a second terminal of the inductor, an output configured to provide an output voltage to a load, a first transistor configured to initiate a charging current in the inductor during a first state of a boost mode and to isolate the first input from ground in a second state of the boost mode, a second transistor configured to couple the first input to the output during the second state of the boost mode and to isolate the first input from the output during the first state of the boost mode, and a bypass switch configured to couple the second input to the output and to bypass the inductor and the second transistor during a bypass mode, and to isolate the second input from the output during the boost mode. In certain examples, the bypass switch can include a metal oxide semiconductor field effect transistor (MOSFET) having a drain node and a source node coupled in series between the second input and the output, a first switch coupled between a bulk node of the MOSFET and the drain, and a second switch coupled between the bulk node and the source.

In Example 2, the boost converter of Example 1 optionally includes control logic configured to control the first transistor, the second transistor and the bypass switch during the boost mode, the bypass mode, and transitions between the boost mode and the bypass mode.

In Example 3, the control logic of any one or more of Examples 1-2 optionally is configured initiate the bypass mode when an interval between transitions of the first and second transistors exceeds a threshold duration, and the output voltage is at or below an input voltage of the second input.

In Example 4, the boost converter of any one or more of Examples 1-3 optionally includes a first comparator configured to receive a representation of the output voltage and a threshold voltage and to provide an indication to the control logic that the output voltage is at or below an input voltage of the second input.

In Example 5, the boost converter of any one or more of Examples 1-4 optionally includes a sampling circuit configured to adjust the voltage threshold using the output voltage and a reference capacitor during a soft start interval of the boost mode.

In Example 6, the control logic of any one or more of Examples 1-5 optionally is configured to receive a forced bypass signal and to disable the boost mode and enable the bypass mode when the forced bypass signal is in a forced bypass state.

In Example 7, the control logic of any one or more of Examples 1-6 optionally is configured to couple the first input to the output using the second transistor when the forced bypass signal is in the forced bypass state.

In Example 8, the boost converter of any one or more of Examples 1-7 optionally includes a third input configured to receive the forced bypass signal.

In Example 9, the boost converter of any one or more of Examples 1-8 optionally includes a first comparator configured to measure a voltage across the bypass switch during the bypass mode and to provide a short circuit indication if the voltage across the bypass switch satisfies a short circuit threshold.

In Example 10, a method can include receiving an input voltage at a first input of a boost converter, establishing an inductor charge current during a first state of a boost mode of the boost converter using a first transistor coupled to an inductor, coupling the inductor charge current to a load during a second state of the boost mode of the boost converter using a second transistor to provide a predetermined output voltage at an output of the boost converter, and bypassing an inductor and the second transistor using a bypass transistor during a bypass mode of the boost converter.

In Example 11, the method of any one or more of Examples 1-10 optionally includes coupling a bulk of the bypass transistor to the input voltage using a first body switch of the bypass transistor when the input voltage is greater than an output voltage of the boost converter.

In Example 12, the method of any one or more of Examples 1-11 optionally includes coupling the bulk of the bypass transistor to the output voltage using a second body switch of the bypass transistor when the output voltage is greater than the input voltage of the boost converter.

In Example 13, the method of any one or more of Examples 1-12 optionally includes receiving a first state of a forced bypass signal at a second input of the boost converter, and transitioning from the boost mode to the bypass mode independent of a difference between the input voltage and the output voltage in response to the first state of the forced bypass signal.

In Example 14, the method of any one or more of Examples 1-13 optionally includes comparing a representation of an output voltage of the boost converter to a threshold to provide a feedback for the boost mode of the boost converter.

In Example 15, the method of any one or more of Examples 1-14 optionally includes transitioning from the bypass mode to the boost mode when a representation of the input voltage becomes less than the threshold.

In Example 16, the method of any one or more of Examples 1-15 optionally includes transitioning from the boost mode to the bypass mode when the output voltage is at or near the threshold and a representation of the input voltage approaches the threshold, wherein the threshold is representative of a predetermined output voltage.

In Example 17, the method of any one or more of Examples 1-16 optionally includes transitioning from the boost mode to the bypass mode when the output voltage is at or near the threshold and a representation of the input voltage becomes greater than the threshold, wherein the threshold is representative of a predetermined output voltage.

Example 18 can include, or can optionally be combined with any portion or combination of any portions of any one or more of Examples 1 through 17 to include, subject matter that can include means for performing any one or more of the functions of Examples 1 through 17, or a machine-readable medium including instructions that, when performed by a machine, cause the machine to perform any one or more of the functions of Examples 1 through 17.

The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A boost converter comprising,
a first input configured to couple to a first terminal of an inductor;
a second input configured to couple to a voltage source and a second terminal of the inductor;
an output configured to provide an output voltage to a load;
a first transistor configured to initiate a charging current in the inductor during a first state of a boost mode and to isolate the first input from ground in a second state of the boost mode;
a second transistor configured to couple the first input to the output during the second state of the boost mode and to isolate the first input from the output during the first state of the boost mode;
a bypass switch configured to couple the second input to the output and to bypass the inductor and the second transistor during a bypass mode, and to isolate the second input from the output during the boost mode; and
wherein the bypass switch includes
a metal oxide semiconductor field effect transistor (MOSFET) having a drain node and a source node coupled in series between the second input and the output;
a first switch coupled between a bulk node of the MOSFET and the drain; and
a second switch coupled between the bulk node and the source.

2. The boost converter of claim 1, including:
control logic configured to control the first transistor, the second transistor and the bypass switch during the boost mode, the bypass mode, and transitions between the boost mode and the bypass mode.

3. The boost converter of claim 2, wherein the control logic is configured initiate the bypass mode when an interval between transitions of the first and second transistors exceeds a threshold duration, and the output voltage is at or below an input voltage of the second input.

4. The boost converter of claim 3, including a first comparator configured to receive a representation of the output voltage and a threshold voltage and to provide an indication to the control logic that the output voltage is at or below an input voltage of the second input.

5. The boost converter of claim 4, including a sampling circuit configured to adjust the voltage threshold using the output voltage and a reference capacitor during a soft start interval of the boost mode.

6. The boost converter of claim 2, wherein the control logic is configured to receive a forced bypass signal and to disable the boost mode and enable the bypass mode when the forced bypass signal is in a forced bypass state.

7. The boost converter of claim 6, wherein the control logic is configured to couple the first input to the output using the second transistor when the forced bypass signal is in the forced bypass state.

8. The boost converter of claim 6, including a third input configured to receive the forced bypass signal.

9. The boost converter of claim 2, including a first comparator configured to measure a voltage across the bypass switch during the bypass mode and to provide a short circuit indication if the voltage across the bypass switch satisfies a short circuit threshold.

10. A method comprising:
receiving an input voltage at a first input of a boost converter;
establishing an inductor charge current during a first state of a boost mode of the boost converter using a first transistor coupled to an inductor;
coupling the inductor charge current to a load during a second state of the boost mode of the boost converter using a second transistor to provide a predetermined output voltage at an output of the boost converter; and
bypassing an inductor and the second transistor using a bypass transistor during a bypass mode of the boost converter.

11. The method of claim 10, including coupling a bulk of the bypass transistor to the input voltage using a first body switch of the bypass transistor when the input voltage is greater than an output voltage of the boost converter.

12. The method of claim 11, including coupling the bulk of the bypass transistor to the output voltage using a second body switch of the bypass transistor when the output voltage is greater than the input voltage of the boost converter.

13. The method of claim 10, including
receiving a first state of a forced bypass signal at a second input of the boost converter; and
transitioning from the boost mode to the bypass mode independent of a difference between the input voltage and the output voltage in response to the first state of the forced bypass signal.

14. The method of claim 10, including comparing a representation of an output voltage of the boost converter to a threshold to provide a feedback for the boost mode of the boost converter.

15. The method of claim 10, including transitioning from the bypass mode to the boost mode when a representation of the input voltage becomes less than the threshold.

16. The method of claim 10, including transitioning from the boost mode to the bypass mode when the output voltage is at or near the threshold and a representation of the input voltage approaches the threshold, wherein the threshold is representative of a predetermined output voltage.

17. The method of claim 10, including transitioning from the boost mode to the bypass mode when the output voltage is at or near the threshold and a representation of the input voltage becomes greater than the threshold, wherein the threshold is representative of a predetermined output voltage.
